(19) United States
(12) Patent Application Publication
(10) Pub. No.: US 2002/0154864 A1
(43) Pub. Date: Oct. 24, 2002

(54) Optical element, and optical transceiver and other optical device using the same

(76) Inventors: Naru Yasuda, Kyoto-shi (JP); Yukari Terakawa, Kyoto-shi (JP); Hayami Hosokawa, Kyoto-shi (JP)

Correspondence Address: ROSENTHAL & OSHA L.L.P., 1221 MCKINNEY AVENUE, SUITE 2800, HOUSTON, TX, 77010, US

(21) Appl. No.: 10/128,476

(22) Filed: Apr. 23, 2002

(30) Foreign Application Priority Data
Apr. 23, 2001 (JP) 2001-125142
Jan. 25, 2002 (JP) 2002-17747

(51) Int. Cl. G02B 6/30; G02B 6/26

(52) U.S. Cl. 385/49; 385/147

(57) ABSTRACT

To couple a light emitted from aa transmitting light guide to an optical fiber with good efficiency, thereby reducing a coupling loss with the optical fiber. The light emitted from the transmitting light guide deviates from an NA of the optical fiber to prevent the loss from occurring. A groove 25 provided on an upper face of a receiving side substrate 22 is filled with a core material to form a receiving light guide 26. A groove 27 provided on a lower face of a transmitting side substrate 24 is filled with the core material to form a transmitting light guide 28 having a linear shape. The receiving side substrate 22 and the transmitting side substrate 24 are joined with a cladding layed interposed so as to optically separate the receiving light guide 26 and the transmitting light guide 28 each other.

The present invention relates to an optical element provided with a transmitting light guide and a receiving light guide, and more specifically relates to an optical transceiver, a connector and other optical device that transmits and receives optical signals to and from an optical fiber in bi-directional directions.

In recent years, the use of high-speed and large-capacity communication networks, and communication control devices has become more common, so that communications via optical fibers has become the mainstream. For example, terminals such as information appliances installed in households are required to be connected with communication networks such as internet via optical fibers for transmitting and receiving signals. In addition, even if a household personal computer is interconnected to television set, DVD, game device and the like, optical fibers tend to be employed. Therefore, there is a great demand for low-cost, compact-size and excellent efficient optical transceiver that may be employed also in household information appliances.

A typical prior art one-core bidirectional optical transceiver is disclosed in Japanese Unexamined Patent Publication No. 11-183743 (1999). FIG. 1 is a horizontal cross sectional view showing a structure of this optical transceiver 1 in which a receiving light guide 3 and a transmitting light guide 4 provided on a substrate 2. The receiving light guide 3 is formed in a linear shape from one end face of the substrate 2 throughout the other end face, and a light receiving element 5 is arranged so as to oppose to the one end face, while the end face of an optical fiber 7 is connected to the other end face. The receiving light guide 3 is formed as a tapered shape having its light guide diameter being large at the optical fiber 7 side, while small at the light receiving element 5 side, in order to combine light beams emitted from the optical fiber and guide the light beams to the light receiving element 5 side and to the light receiving element 5. And, a light projecting element 6 is arranged adjacent to the light receiving element 5, and a transmitting light guide 4 starts from the position facing the light projecting element 6, expands in diagonal direction in a linear shape, and is connected integrally to the end of the receiving light guide 3 at the optical fiber side. This transmitting light guide 4 is for combining light beams from the light projecting element 6 such as a semiconductor laser or so, and guiding the light beams to the optical fiber 7 side, and the light guide diameter thereof is made smaller in comparison with that of the receiving light guide 3.

In optical transceivers according to the prior art, when external dimensions of a light projecting element and a light receiving element are not sufficiently small to the cross sectional dimensions of an optical fiber, it is not possible to configure a transmitting light guide and a receiving light guide parallel with each other, accordingly, both the receiving light guide and the transmitting light guide, or either thereof must be inclined aslant to the optical fiber 7. For this reason, in the optical transceiver 1 shown in FIG. 1, the transmitting light guide 4 is inclined aslant.

As mentioned above, in the optical transceiver 1, the transmitting light guide 4 is inclined aslant, as a consequence, when light beams emitted from the light projecting element 6 are guided through the transmitting light guide 4 and go into the optical fiber 7, the light beams will go into there in a direction inclined to the optical axis of the optical fiber 7, as a result, part of the light beams will go out from NA (Numerical Aperture) of the optical fiber 7. Even if light beams out of NA go into the optical fiber once, they will go out of the optical fiber, as a result, light beams will not be combined into the optical fiber 7 only to be lost.

For instance, even if the light intensity distribution with the outgoing optical axis direction as reference of the outgoing light emitted from the transmitting light guide 4 of the optical transceiver 1 is within the range of NA of the optical fiber as shown in FIG. 2A, when the light emitted from the optical transceiver 1 is displaced from the optical axis of the optical fiber 7, the light intensity distribution is displaced as shown in FIG. 2B when the light intensity distribution of FIG. 2A is viewed from the angle with the optical axis of the optical fiber 7 as reference, as a consequence, the light out of the NA range of the optical fiber 7 (the light in the shaded area in FIG. 2B) will be lost, which may be a problem.

Further, since the end of the transmitting light guide 4 is connected aslant to the end of the receiving light guide 3, the transmitting light guide 4 is bent, which will lead to loss at the bent portion thereof, which may be a problem.

### SUMMARY OF INVENTION

In one aspect, the present invention provides an optical transceiver or an optical element that enables light beams emitted from a transmitting light guide to be coupled in an efficient manner, and to make joint loss with an optical fiber small. Moreover, the present invention prevents light beams emitted from a transmitting light guide from going out of NA of an optical fiber and becoming a loss.

In one embodiment, an optical element according to the present invention includes a transmitting light guide and a receiving light guide individually, wherein the transmitting light guide is formed in a linear shape, while the receiving light guide is formed in a curved shape.

In one embodiment, in the optical element of the present invention, since the transmitting light guide is made into linear shape, the loss at the curved portion of the transmitting light guide is eliminated. On the other hand, on the light receiving side wherein a light receiving element and the similar are arranged, a light receiving view is generally large, and the angle for receiving light is not limited like NA of an optical fiber, accordingly, a receiving light guide may not be of a linear shape, but may of other shape that is enough to guide light beams by total reflection. Therefore, by making a receiving light guide curved moderately, it is possible to combine light beams into the light receiving side, while avoiding the interference between a transmitting light guide and a receiving light guide, or between the light projecting side of a light projecting element and the like and the light receiving side of a light receiving element and the similar.

As a consequence, even when light projecting and receiving sides comprising a light projecting element, a light receiving element and so forth are not so small in comparison with an optical fiber, according to the present invention, it is possible to realize an optical element whose optical use efficiency is high, transmission distance is long, and S/N ratio of signals is preferable.

According to an embodiment of another optical element according to the present invention, since the transmitting light guide is arranged in parallel with the connection direction with an optical fiver, light beams emitted from the transmitting light guide hardly go out of NA of an optical fiber, therefore it is possible to lessen the loss of light further.

According to an embodiment of another optical element according to the present invention, one side face of the receiving light guide is formed only with a curved face, while the other side face thereof is formed with a flat face and a curved face.

Moreover, according to an embodiment of another optical element according to the present invention, since the end of the transmitting light guide and the end of the receiving light guide are piled in the direction perpendicular to the curving direction of the receiving light guide, light beams going into the area where the end of the transmitting light guide and the end of the receiving light guide are piled are projected via the transmitting light guide to the other end face of the receiving light guide. Therefore, according to this embodiment, it is possible to transmit light for transmission and light for reception via a one-core optical fiber or the similar. Furthermore, according to this optical element, a transmitting light guide and a receiving light guide may be designed without restrictions to light guide at another side mutually, and light may be controlled in free manners. As a result, it is possible to design an optical element so as to make the loss and cross talk of light small.

Furthermore, according to an embodiment of another optical element according to the present invention, since a light beam control unit for controlling light angle is arranged at the transmitting light guide, it is possible to control so as to make the light emitted from the transmitting light guide into the light in NA of an optical fiber, as a consequence, it is possible to make the loss of light further smaller.

Another optical element according to the present invention may be embodied as one comprising a transmitting light guide and a receiving light guide individually, characterized in that the face of the transmitting light guide that is the farther from the receiving light guide is inclined, at least at the end of the transmitting light guide at the optical fiver side, so that the cross sectional area of the transmitting light guide should become larger as it goes nearer to an optical fiver side.

In this optical element, it is possible to arrange the direction of outgoing light in the direction parallel to the optical axis of an optical fiber, just before light comes out of the transmission light guide, thereby it is possible to reduce the loss of light. Moreover, by making the face of the side that is the farther from the receiving light guide is inclined, thereby it is possible to lessen light beams that reflect into the receiving light guide side, and consequently it is possible to reduce cross talk.

In one embodiment, an optical transceiver of the present invention is equipped with an optical element according to the present invention, a light projecting element arranged so as to oppose to the end face of the transmitting light guide, and a light receiving element arranged so as to oppose to the end face of the receiving light guide.

In one embodiment, according to the optical transceiver of the present invention, since the transmitting light guide which transmits the light coming out of the light projecting element is formed in a linear shape, transmitting loss is eliminated. On the other hand, since the receiving light guide for making the light receiving element receive light is curved moderately, it is possible to combine light beams into the light receiving element, while avoiding the interference between the transmitting light guide and the receiving light guide, or between the light projecting element and the light receiving element, and also suppressing the loss of light.

Therefore, even when a light projecting element and a light receiving element are not so small in comparison with an optical fiber, according to the present invention, it is possible to realize an optical element whose optical use efficiency is high, transmission distance is long, and S/N ratio of signals is preferable.

In one embodiment, a connector of the present invention is characterized in being equipped with an optical element according to the present invention, wherein an optical fiber is connected to the optical element so as to oppose to the portion wherein the end of the transmitting light guide and the end of the receiving light guide are piled.

In one embodiment, according to the connector of the present invention, the other ends of transmitting light guide and receiving light guide may be connected with connectors such as an optical transceiver and the similar, and thereby it is possible to transmit the transmitted signals and received signals thereof by means of a one-core optical fiber (a first optical fiber).

In one embodiment, a two-cores/one-core conversion adapter of the present invention is equipped with an optical element according to the present invention, and characterized in that a first optical fiber is connected to the optical element so as to oppose to the portion wherein the end of the transmitting light guide and the end of the receiving light guide are piled, and a second optical fiber is connected so as to oppose to the other end of the transmitting light guide, and a third optical fiber is connected so as to oppose to the other end of the receiving light guide, and a connecting portion with a two-cores connection cord is arranged at least at a covered portion wherein the optical element is sealed.

In one embodiment, according to the two-cores/one-core conversion adapter of the present invention, it is possible to connect the second and third optical fibers to a two-cores cord, and connect the first optical fiber to a one-core cord, and connect the two-cores cord and the one-core cord, thereby to convert a two-cores cord into a one-core cord.

As mentioned above, according to the optical transceiver, connector, and two-cores/one-core conversion adapter, when bidirectional light beams of transmission side and receiving side may be transmitted by means of a one-core optical fiber, it is possible to make the cost of an optical fiber lower, and to make the size of optical fiber small, thereby to make and handling easier.

By the way, the composition elements of the present invention explained above may be combined arbitrarily as many as possible.

### BRIEF DESCRIPTION OF DRAWINGS

FIG. 1 is a schematic horizontal sectional view showing a structure of a conventional optical transceiver;

FIG. 2A is a diagram showing light intensity distribution of light emitted from a transmitting light guide, and

FIG. 2B is a diagram showing the light intensity distribution when viewed from an optical fiber;

FIG. 3 is a perspective view showing an optical transceiver according to one embodiment of the present invention;

FIG. 4 is an exploded perspective view showing an optical wave guide circuit used in the above-mentioned optical transceiver;

FIG. 5A is a diagram showing a light projecting/receiving side end face of the above-mentioned optical transceiver, and

FIG. 5B is a view showing an optical fiber coupling side end face;

FIG. 6 is a view showing an arrangement of a receiving light guide and a transmitting light guide in the optical fiber side coupling end face;

FIG. 7 is a diagram showing a transmitting light guide and light beams transmitted through the inside thereof;

FIG. 8 is a diagram showing a receiving light guide and light beams transmitted through the inside thereof;

FIGS. 9A and 9B are diagrams showing the comparison of the case where an end portion of a receiving light guide and an end portion of a transmitting light guide are horizontally arranged in a line, and the case where these are laminated vertically;

FIG. 10 is a schematic sectional view showing another embodiment of the present invention;

FIG. 11 is a schematic sectional view showing still another embodiment of the present invention;

FIG. 12 is a schematic sectional view showing yet another embodiment of the present invention;

FIG. 13 is a perspective view showing an optical transceiver according to yet another embodiment of the present invention;

FIG. 14 is a plan view showing a light beam control portion provided in the above-mentioned optical transceiver;

FIG. 15 is a perspective view of a connector using an optical wave guide circuit according to the present invention;

FIG. 16 is an enlarged cross sectional view of the above-mentioned connector;

FIG. 17 is an explanatory diagram showing a connection condition where optical transceivers of two apparatus are connected by a one-core connection cord provided with the above-mentioned connector at both ends;

FIG. 18A is a schematic diagram showing a structure of a conventional two-cores connection cord for connecting optical transceivers of two apparatus, and

FIG. 18B is a sectional view showing a connector employed in the conventional connection cord;

FIG. 19 is a schematic diagram showing a one-core connection cord that an optical transceiver is arranged at one end portion, and a connector is arranged at the other end portion; and

FIG. 20 is a cross sectional view showing a one-core connection cord wherein a two-cores/one-core conversion adapter is arranged at one end.

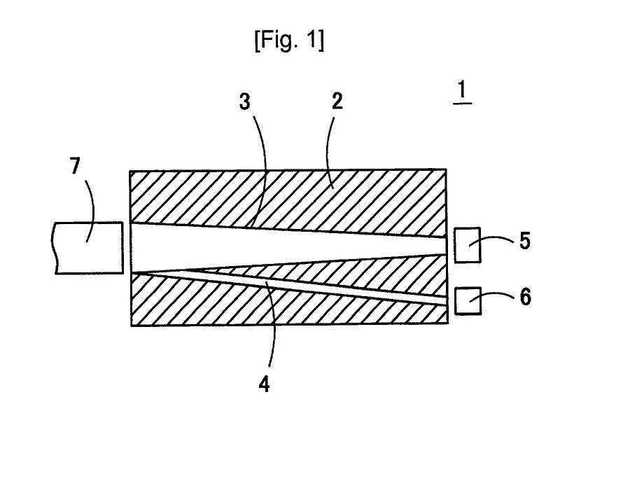

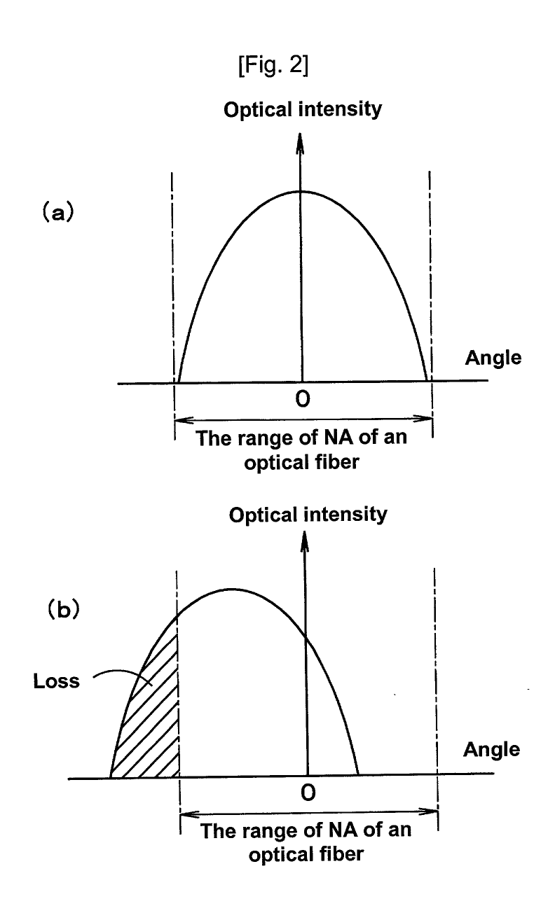

### DETAILED DESCRIPTION

The present invention is illustrated in more details by reference to the following referential examples and embodiments wherein.

(First Embodiment)

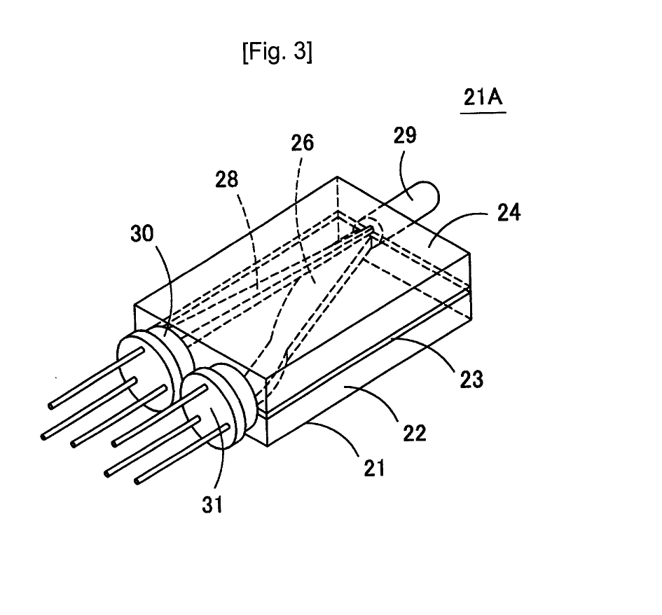

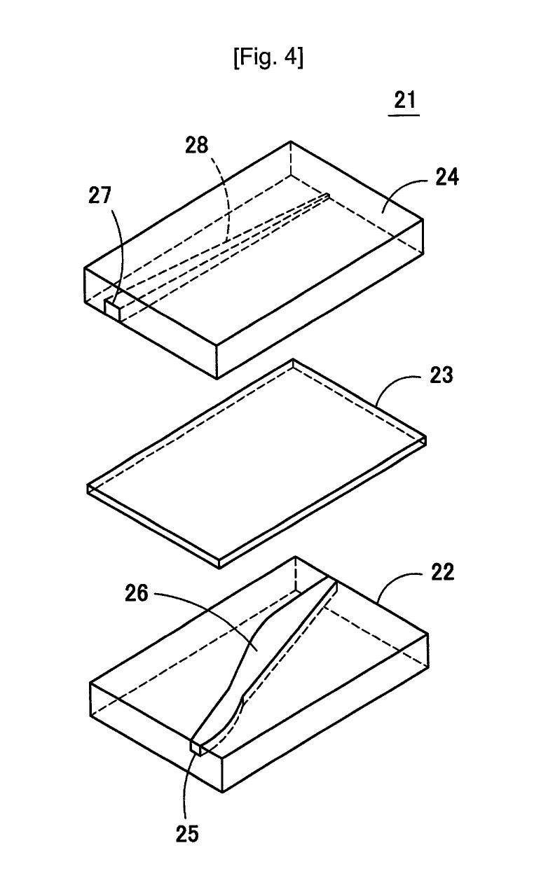

FIG. 3 is the perspective diagram showing an optical transceiver 21A according to one embodiment of the present invention, and FIG. 4 is an exploded perspective diagram showing an optical wave guide circuit 21 used in a transceiver 21. This optical wave guide circuit 21 comprises a receiving side substrate 22, a cladding layer 23, and a transmitting side substrate 24, and the receiving side substrate 22 and the transmitting side substrate 24 are jointed into a body via the cladding layer 23.

The receiving side substrate 22 is formed of transparent resin (for example, PMMA—polymethyl methacrylate; refractive index 1.49), and a slot 25 whose both side edges are constituted by a straight line and a curve respectively is arranged on the upper face thereof, and the inside of the slot 25 is filled up with transparent resin (core material; refractive index 1.6) with a refractive index higher than that of the transparent resin used as the substrate material so as to form a receiving light guide 26. While, the transmitting side substrate 24 is also formed of transparent resin (for example, PMMA; refractive index 1.49), and a taper-shaped slot 27 is arranged on the underface thereof, and the inside of the slot 27 is filled up with transparent resin (core material; refractive index 1.6) with a refractive index higher than that of the transparent resin used as the substrate material so as to form a transmitting light guide 28. The cladding layer 23 is the thin film (refractive index 1.36) formed of ultraviolet ray hardening resin and the similar, and has a refractive index smaller than the refractive indexes of the receiving light guide 26 and the transmitting light guide 28. As for the cladding layer 23, it is preferable to make it as thin as possible.

The receiving side substrate 22, the cladding layer 23, and the transmitting side substrate 24 are laminated into a body by adhering up the receiving side substrate 22 and the transmitting side substrate 24 by the cladding layer 23, and the receiving light guide 26 and the transmitting light guide 28 are covered with the cladding layer 23.

With regard to the optical transceiver 21A, as shown in FIG. 3, an optical fiber 29 is connected to one end face of the optical wave guide circuit 21, while a light projecting element 30 and a light receiving element 31 are arranged on the other end face thereof. For example, when such an optical transceiver 21A as shown herein is used for an apparatus such as an information appliance or so, the light projecting element 30, the light receiving element 31, and the optical wave guide circuit 21 are beforehand attached into the inside of an apparatus such as an information appliance or so, while one end of an optical fiber 29 is connected to a connector prepared in the apparatus such as an information appliance, and the other end of the optical fiber 29 is combined with the end face of optical fiber combination side of the optical wave guide circuit 21, and the optical transceiver 21A and the connector are connected with each other via the optical fiber 29.

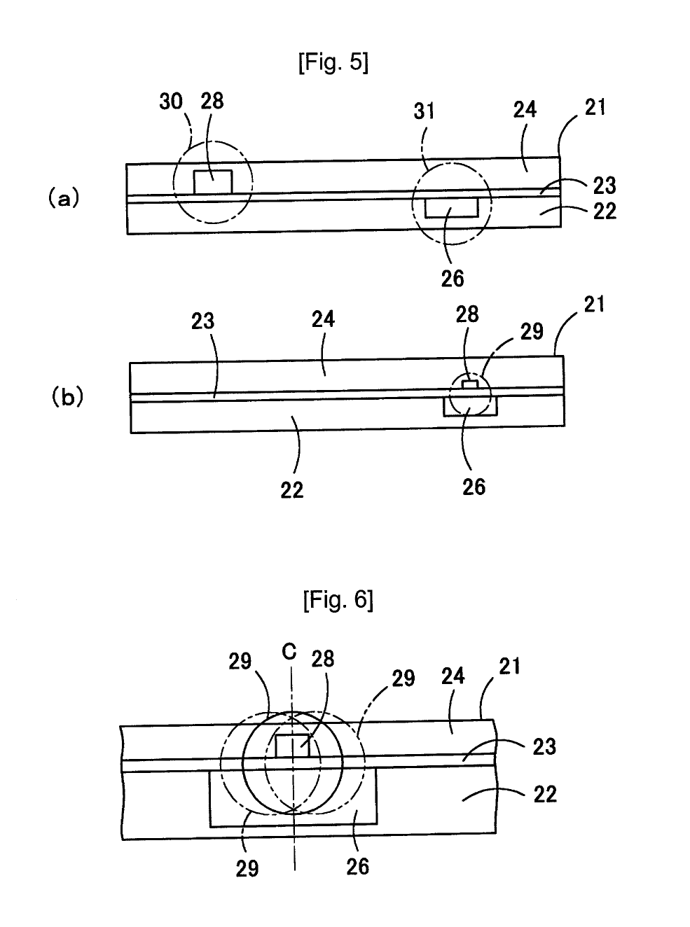

At the optical fiber joint side end face of the optical wave guide circuit 21, as shown in FIG. 5B, the end face of transmitting light guide 28 and the end face of receiving light guide 26 are arranged so as to oppose to each other vertically via the cladding layer 23. At the end face of the optical fiber combination side, the end face dimension of the transmitting light guide 28 is so made to have a smaller area than the end face dimension (core diameter) of an optical fiber 29, and is arranged so that it may be arranged within the end face of the optical fiber 29, accordingly, light beams emitted from the transmitting light guide 28 are made to go into the optical fiber 29 at high efficiency. And, in the area below the cladding layer 23, the end face dimension of the receiving light guide 26 is made to have a larger area than the end face dimension of the optical fiber 29, and the end face of the optical fiber 29 is totally included within the end face of the receiving light guide 26, as a consequence, light beams emitted from the optical fiber 29 are taken into the receiving light guide 26 at high efficiency.

Since the transmitting light guide 28 is formed in a linear shape and the receiving light guide 26 is formed in a curved shape, in at the end face wherein the light projecting element 30 and the light receiving element 31 are arranged (hereinafter referred to as light projecting/receiving end face), the end face of receiving light guide 26 and the end face of transmitting light guide 28 are arranged apart from each other horizontally. As shown in FIG. 5A, the light projecting element 30 is arranged so as to oppose to the end face of the transmitting light guide 28, and the light receiving element 31 is arranged so as to oppose to the end face of receiving light guide 26. The transmitting light guide 28 is formed in a tapered shape, and the circumference thereof is surrounded by the transmitting side substrate 24 and the cladding layer 23 of a refractive index lower than that of the transmitting light guide 28. In the transmitting light guide 28, the end face area at the light projecting/receiving end face is made larger than that of the optical fiber joint side end face, thereby the transmitting light guide 28 catches light beams emitted from the light projecting element 30 by a larger area and transmits light beams to the optical fiber joint side end face, and projects light beams through a smaller area and makes light beams go into the core of the optical fiber 29 so as to eliminate loss as much as possible. Consequently, the optical use efficiency of the transmitting light guide 28 is nearly 100%. Moreover, the circumference of the receiving light guide 26 is surrounded by the receiving side substrate 22 and the cladding layer 23 of a lower refractive index than that of the receiving light guide 26, and it has a larger end face dimension at the optical fiber joint side end face, while it has a smaller end face size at the light projecting/receiving end face, thereby the receiving light guide 26 efficiently catches light beams coming out of the optical fiber and guides them to the light receiving element 31. Consequently, the optical use efficiency of the receiving light guide 26 is nearly 100%.

In this optical transceiver 21A, since the receiving side substrate 22 and the transmitting side substrate 24 are separated by the cladding layer 23, there is no interference between the light beams that are transmitted through the receiving side substrate 22 and the light beams that are transmitted through the transmitting side substrate 24. Moreover, also at the optical fiber joint side end face, since the receiving side substrate 22 and the transmitting side substrate 24 are separated by the cladding layer 23, even if the light emitted from the transmitting light guide 28 is reflected on the end face of the optical fiber 29, it is hard to go into the receiving light guide 26, and the cross talk between the receiving light guide 26 and the transmitting light guide 28 may be prevented.

Moreover, in this optical wave guide circuit 21, as shown by the line C-C in FIG. 6, on optical fiber joint side end face, the central axis of the receiving light guide 26 and the central axis of the transmitting light guide 28 are in alignment with each other.

For this reason, even if the connecting position of the optical fiber 29 displaces from the standard position shown by the solid line in FIG. 6 and shifts to the positions by the one-dot chain line and the two-dot chain line shown in FIG. 6, the overlapping area of the optical fiber 29 and the transmitting light guide 28, or the overlapping area of the optical fiber 29 and the receiving light guide 26 will not change. Therefore, according to such an structure mentioned above, the degree of allowance to unevenness in the joint position of the optical fiber 29 becomes large, leading to the strength to the unevenness in the joint position of the optical fiber 29.

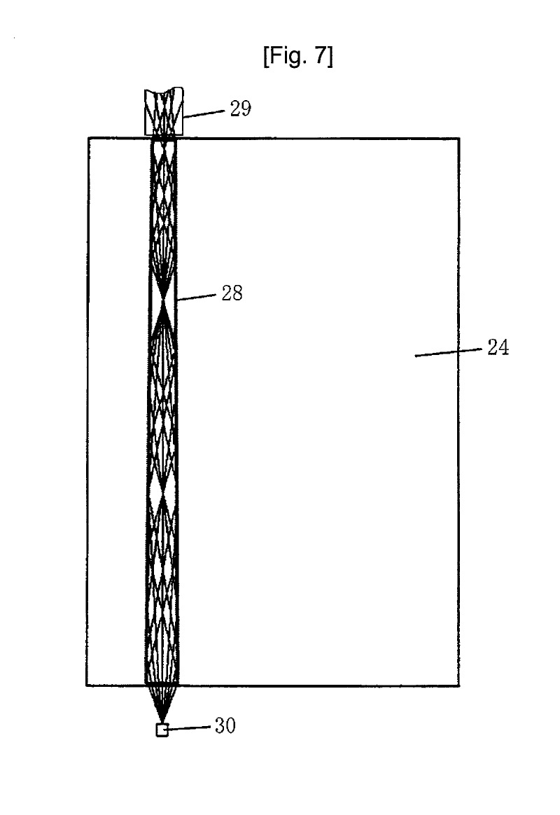

In the next place, the receiving light guide 26 and the transmitting light guide 28 are explained in detail hereinafter. The transmitting light guide 28 is straightly prolonged in a linear shape from the light projecting/receiving end face towards the optical fiber joint side end face, and is formed in a tapered shape so that the cross sectional area at the light projecting element 30 side is larger, and that at the cross sectional area at the optical fiber 29 side becomes smaller. Furthermore, the receiving light guide 26 is formed so that the direction of an axial center should become parallel with the connecting direction of the optical fiber 29, or the optical axis direction of the optical fiber 29. Thereby, as shown in FIG. 7, light beams emitted from the light projecting element 30 are combined at the end face of transmitting light guide 28 and go into the transmitting light guide 28, and repeat total reflection in the transmitting light guide 28, and go on to the optical fiber 29 side. Since the transmitting light guide 28 is of a linear shape, and is arranged parallel with the optical axis of an optical fiber 29, light beams emitted from the end face of the transmitting light guide 28, as light beams nearly within NA of the optical fiber 29, go into the optical fiber 29. Therefore, when light beams go into the optical fiber 29 from the transmitting light guide 28, the loss of light beams may be suppressed small.

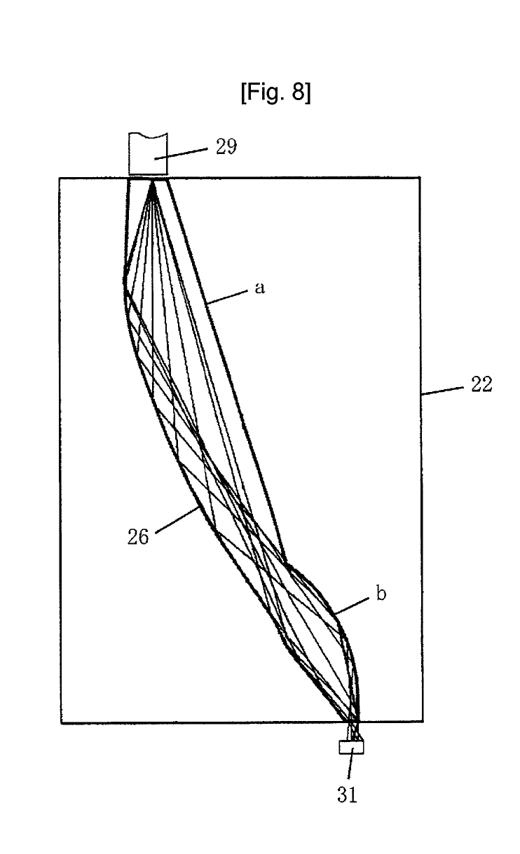

The receiving light guide 26 is curved in the face parallel to the receiving side substrate 22, between one side of the optical fiber joint side end face and the other side of the light projecting/receiving end face, as shown in FIG. 8. When viewed in top appearance, the side face of the receiving light guide 26 is constituted by a straight and a curved line, and the end face at the side of the optical fiber of the receiving light guide 26 has a comparatively large area, while the end face at the side of the light receiving element 31 has a comparatively small area. Thereby, light beams going into the receiving light guide 26 from the optical fiber 29, through several times of total reflection on the side face of the receiving light guide 26, are guided to the light receiving element 31 side, and are collected to the end face of the small area. And light beams emitted from the end face at the light receiving element 31 side are received by the light receiving element 31. By the way, incidence of the light is hardly carried out to the linear portion among the side face of the receiving light guide 26, and there is no reflected light in the curved portion b which continues to the straight line portion.

In the optical fiber joint side end face, the end face of the receiving light guide 26 and the end face of the transmitting light guide 28 are overlapped in the laminating direction of the optical wave guide circuit 21, as shown in FIG. 5B. And since the receiving light guide 26 is curved within the plane perpendicular to the laminating direction of the optical wave guide circuit 21, at the light projecting/receiving end face of the optical wave guide circuit 21, the end face of the receiving light guide 26 and the end face of the transmitting light guide 28 are located in a line in almost horizontal direction. Therefore, in this optical wave guide circuit 21, the receiving light guide 26 and the transmitting light guide 28 are vertically located in a line at the optical fiber joint side end face, while they are located almost horizontally in a line at the light projecting/receiving end face, which may be called a twisted structure.

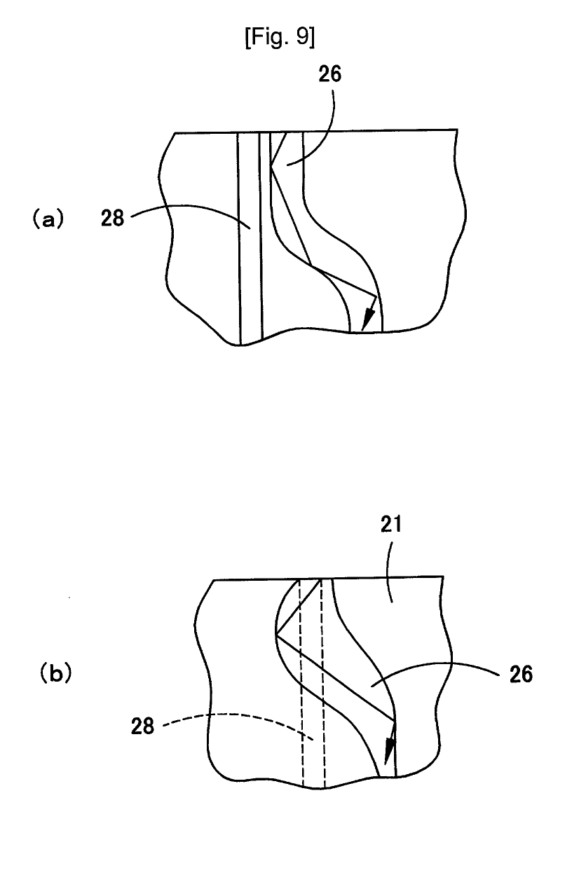

FIGS. 9A and 9B show the comparison of the case wherein the end of the receiving light guide 26 and the end of the transmitting light guide 28 are horizontally located in a line, and the case wherein these are laminated vertically. Since it is necessary to connect the receiving light guide 26 and the transmitting light guide 28 to the optical fiber 29, it is impossible to arrange them apart from each other at the optical fiber joint side end face. Therefore, as shown in FIG. 9A, when the receiving light guide 26 and the transmitting light guide 28 are formed in the same plane, there will be restrictions in designing the receiving light guide 26 and the transmitting light guide 28, and it becomes difficult to shut light up. On the other hand, when the receiving light guide 26 and the transmitting light guide 28 are arranged on different planes as shown in FIG. 9B, it is possible to design the receiving light guide 26 and the transmitting light guide 28 without restrictions by other light guide, and thereby light may be controlled freely. Therefore, the spread of the optical beams in between the light projecting element 30 and the light receiving element 31 can be shut up in the thickness direction of the light guides 26 and 28, leading to effective reduction of a cross talk.

(Second Embodiment)

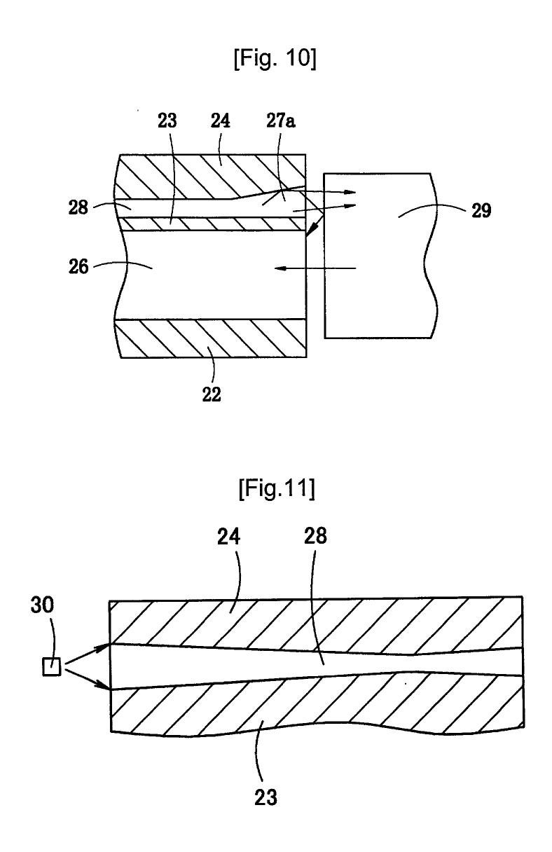

FIG. 10 is a schematic cross sectional view showing another embodiment of the present invention. In this optical wave guide circuit, the upper face of transmitting light guide 28 (the face which is the farther from the light guide 26) is inclined on the portion near the optical fiber joint side end face of the transmitting light guide 28, and the cross sectional area of the transmitting light guide 28 is made larger toward the an optical fiber side. When the optical fiber 29 side is made so as to spread at the end of the transmitting light guide 28, light beams totally reflected on the upper face of the transmitting light guide 28 in this area are arranged almost in parallel with the optical axis of an optical fiber 29, and easily combined into the optical fiber 29, without being reflected on the end face of the optical fiber 29. Therefore, the loss of light decrease. Moreover, since light beams reflected at the end face of the optical fiber 29 hardly go into the light guide 26, a cross talk also reduces. By the way, the face that is nearer to the light guide 26 may be inclined too.

Moreover, in the embodiment shown in FIG. 11, the upper face of the transmitting light guide 28 is inclined so that the cross section of the transmitting light guide 28 should become smaller gradually as it goes from the light projecting element 30 side to the optical fiber 29 side (the underface thereof may be also inclined), and at the position wherein the cross sectional minimum of the transmitting light guide 28 is exceeded, the upper face of transmitting light guide 28 is inclined reversely so that the cross section of the transmitting light guide 28 should become larger gradually again (the underface thereof may be also inclined reversely). Herein, it is preferable to make as thin as possible the portion of the minimum cross section of the transmitting light guide 28 in the range wherein the loss of light does not occur. According to this embodiment, by stopping down the light of the light projecting element 30 thinly by the transmitting light guide 28, it is possible to bring the direction of the light that goes out last close to the optical axis of the optical fiber 29, and thereby to reduce the loss and cross talk of light.

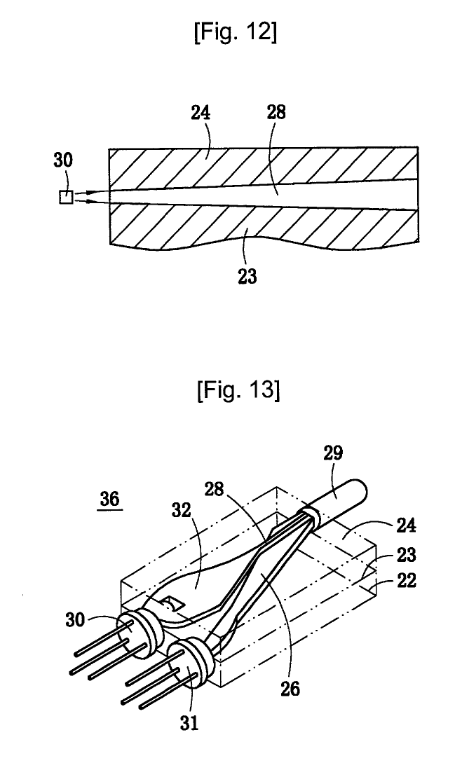

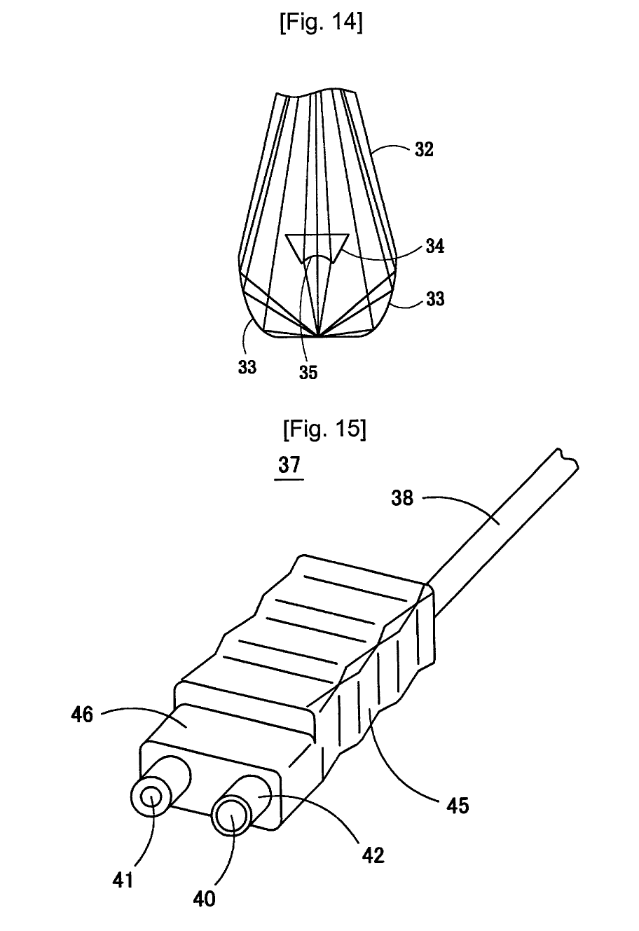

Or, in the case when NA of the light going into the transmitting light guide 28 from the light projecting element 30 is small enough, as shown in FIG. 12, the upper face of the transmitting light guide 28 may be inclined for full length, and thereby the cross sectional area of the transmitting light guide 28 may be arranged so as to become larger as it goes near the optical fiber 29 side.

(Third Embodiment)

FIG. 13 is a perspective view showing an optical transceiver 36 according to still another embodiment of the present invention. In this embodiment, a light control portion 32 is arranged at the transmitting light guide 28 near the light projecting element 30. The light control portion 32 consists of concave reflective portions 33 prepared in both sides, and a convex lens portion 35 formed at the edge of a cave 34. In this structure mentioned above, light beams going from light projecting element 30 into the transmitting light guide 28 at a large angle are totally reflected by the concave reflective portion 33, and are arranged into light beams near in parallel, and light beams emitted to the central portion are also arranged into roughly parallel light beams by the convex lens portion 35. Therefore, light beams emitted from the transmitting light guide 28 become light beams in NA of the optical fiber 29 and are combined by the optical fiber 29, as a result, it is possible to make the loss of light extremely small. Especially, such an embodiment as shown herein is effective when using a light projecting element 30 which spreads at a comparatively large angle like the beam of a long axis direction, such as a semiconductor laser (LD) and a light emitting diode (LED).

(Fourth Embodiment)

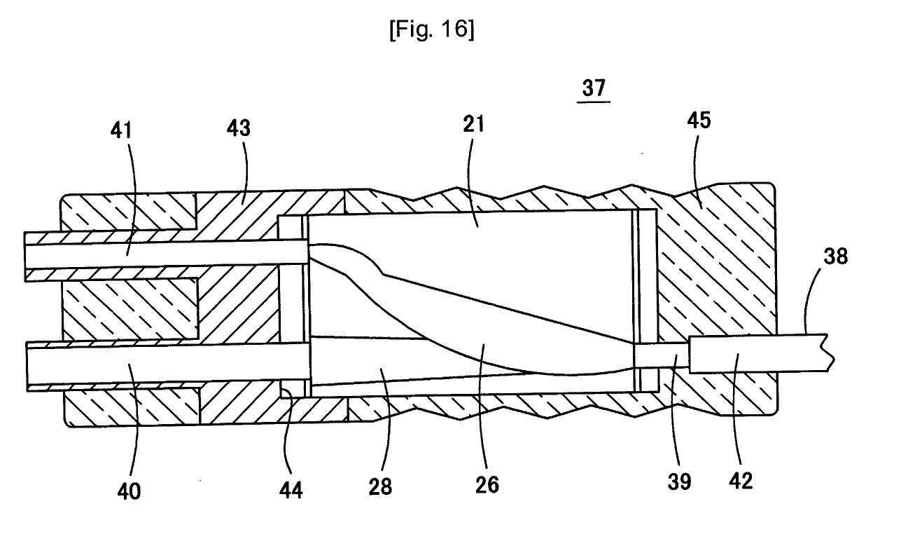

FIG. 15 is a perspective view of the connector 37 using an optical wave guide circuit 21 according to the present invention, and FIG. 16 is an enlarged cross sectional view thereof. In the connector 37 shown herein, the optical wave guide circuit 21 which was explained, for example, in the first embodiment (FIG. 3 to FIG. 8) is employed. Namely, the transmitting light guide 28 in the optical wave guide circuit 21 is formed in a tapered shape, and the end face of the side with a smaller area of the transmitting light guide 28 and one end face of the receiving light guide 26 are piled up in laminating direction via the cladding layer 23. One fiber transmission line 38 is connected to the optical wave guide circuit 21, at the side wherein this transmitting light guide 28 and the receiving light guide 26 are piled up. The fiber transmission line 38 consists of an optical fiber 39 made of plastic and covered with a covering 42, and the exposed end face of the optical fiber 39 with the covering 42 peeled off is connected to the end faces of the transmitting light guide 28 and the receiving light guide 26 (Refer to FIG. 5B).

Moreover, the end face of the optical fiber 40 whose cross sectional area is smaller than that of the end face concerned is connected to the end face whose area is the larger of the transmitting light guide 28, while the end face of the optical fiber 41 whose cross sectional area is larger than that of the end face concerned is connected to the other end face of the receiving light guide 26. The circumferential faces of the optical fibers 40 and 41 are covered with a sleeve material 43, while the end faces of the optical fibers 40 and 41 are exposed from the sleeve material 43. Moreover, a concave portion 44 is formed in the sleeve material 43, and the end of the optical wave guide circuit 21 is inserted into the concave portion 44 concerned, thereby the sleeve material 43, the optical fibers 40 and 41 are positioned to the optical wave guide circuit 21.

Furthermore, the tip portions of the optical wave guide circuit 21 and the fiber transmission line 38 and part of the sleeve material 43 are covered by a resin covered portion 45, and the tip part of the sleeve material 43 is protruded from the end face of the resin covered portion 45, and the end faces of the optical fibers 40 and 41 are exposed at the tip thereof. Moreover, an engaging portion 46 for mechanically engaging with a corresponding connector is formed at the tip part of the resin covered portion 45.

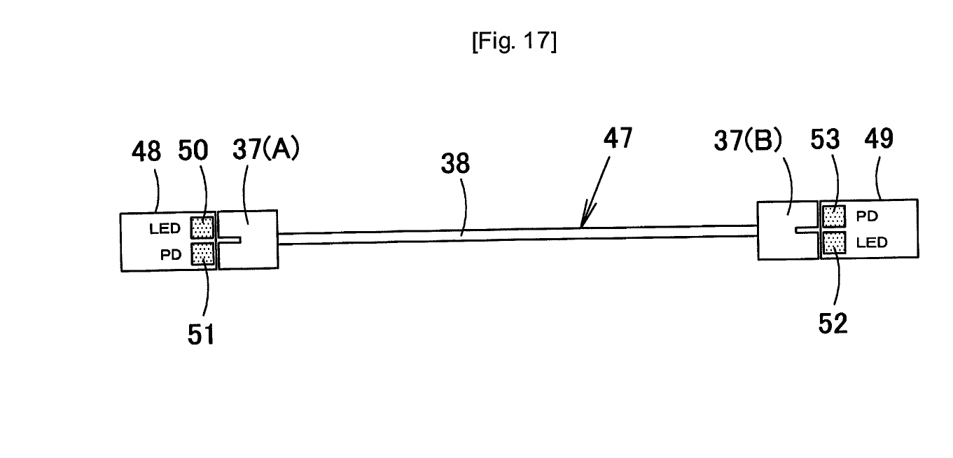

FIG. 17 shows a connection cord (cable) 47 wherein the above-mentioned connector 37 is arranged at the both ends of a one-core fiber transmission line 38. This connection cord 47 is used in order to connect the optical transceivers 48 and 49 formed in two individual apparatus, and a connector 37(A) at one end is connected to a connector (not illustrated herein) arranged in an optical transceiver 48 (or an apparatus wherein the optical transceiver 48 is formed), and a connector 37(B) at the other side is connected to a connector (not illustrated herein) arranged in the optical transceiver 49. Thereby, the optical signals transmitted from the light projecting element 50 of the optical transceiver 48 are combined into the fiber transmission line 38 via the connector 37(A), and spread through the fiber transmission line 38, and reach at the connector 37(B), and are received by the light receiving element 53 of the optical transceiver 49 from the connector 37(B). On the contrary, optical signals transmitted from the light projecting element 52 of the optical transceiver 49 are combined into the fiber transmission line 38 by the connector 37(B), and spread through the fiber transmission line 38, reach at the connector 37(A), are received by the light receiving element 51 of the optical transceiver 48 from the connector 37(A).

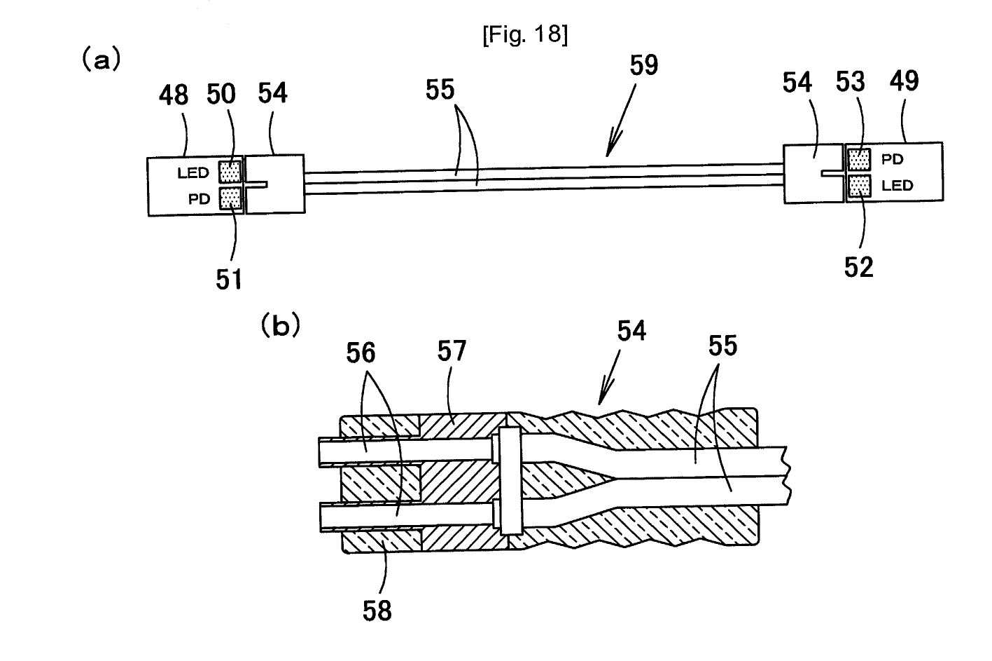

In the conventional connector 54, as shown in FIG. 18B, the covering of two fiber transmission lines 55 is removed, and the tip of the optical fiber 56 is exposed, and the tip part of both the optical fibers 56 is covered with the sleeve material 57, and further covered with the resin covered portion 58. And as shown in FIG. 18A, the optical transceivers 48 and 49 are connected by a two-cores connection cord 59 wherein this connector 54 is arranged at both ends of two fiber transmission lines 55. That is, the light projecting element 50 of the optical transceiver 48 and the light receiving element 53 of the optical transceiver 49 are directly connected by one fiber transmission line 55, and the light projecting element 52 of the optical transceiver 49 and the light receiving element 51 of the optical transceiver 48 are directly connected by the other fiber transmission line 55.

Therefore, according to the conventional method, when connecting the optical transceivers 48 and 49 each of which has a light projecting element and a light receiving element, the two-cores connection cord 59 is required, while, by use of the connector 37 according to the present invention, it is possible to connect them by the one-core fiber transmission line 38, as a consequence, it is possible to reduce the cost of the connection cord 47. Moreover, even when rolling round and keeping it at the time of needlessness, it is not bulky.

In the above-mentioned optical transceivers 48 and 49, when a light projecting element and a light receiving element and connectors are connected by two optical fibers respectively, the connector 37 also functions as a two-cores/one-core conversion adapter.

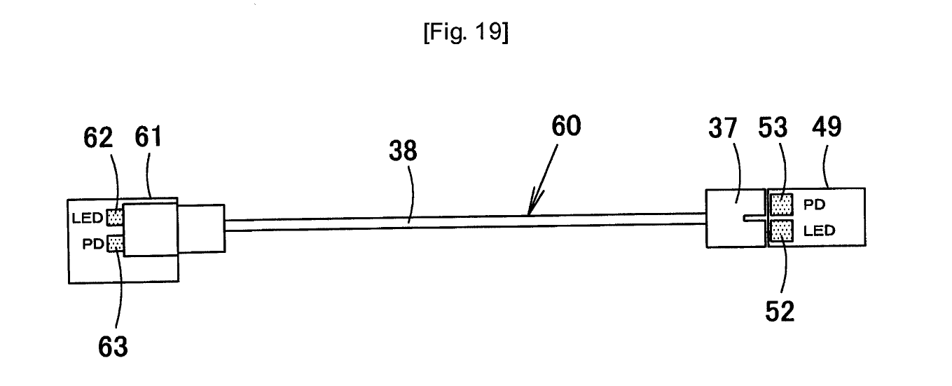

FIG. 19 shows a connection cord 60 wherein a connectors 37 as shown above is formed at one end of the one-core fiber transmission line 38, and an optical transceiver 61 (for example, the optical transceiver as shown in FIG. 3) is formed at the other end. By such a structure mentioned above, a connector 37 will become unnecessary at one side of the fiber transmission line 38, and cost may be reduced further. And further, by connecting the connector 37 at one side to the optical transceiver 49, it is possible to conduct bidirectional communications among the light projecting element 62 of the optical transceiver 61 and the light receiving element 63 and the light receiving element 53 of the optical transceiver 49, and the light projecting element 52, and moreover, by removing the connector 37 from the optical transceiver 49, it is possible to separate the optical transceivers 61 and 49.

(Fifth Embodiment)

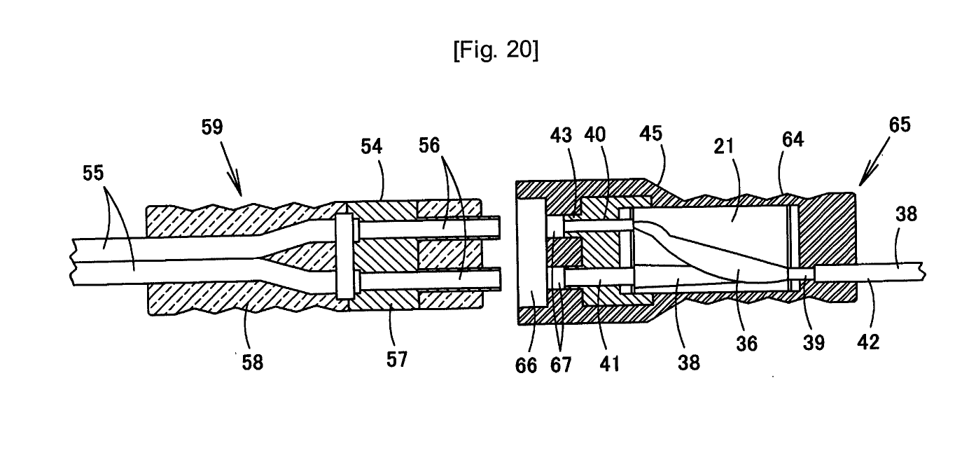

FIG. 20 shows a one-core connection cord 65 wherein a two-cores/one-core conversion adapter 64 for connecting a two-cores connection cord 59 with the one-core connection cord is arranged at one end. The connector 54 arranged at the end of two-cores connection cord 59 is the same as the one shown in FIG. 18B. Although the two-cores/one-core conversion adapter 64 arranged at the end of the one-core connection cord 65 has the almost same structure as that of the connector shown in FIG. 16, while it has the a concave portion 66 for making the tip portion of the connector 54 insert and a hole 67 for making the tip portion of an optical fiber 56 insert, in order to connect with the connector 54, and when the connector 54 is inserted into the concave portion 66 and the connector 54 and the two-cores/one-core conversion adapter 64 are connected, the end face of the optical fiber 56 of the connector 54 and the end face of the optical fibers 40 and 41 of the two-cores/one-core conversion adapter 64 are arranged to face with each other.

Therefore, by using such a two-cores/one-core conversion adapter 64, it is possible to convert the two-cores connection cord 59 into the one-core connection cord 65, and to carry out bidirectional communications of optical signals via the one-core connection cord 65.

A light projecting element and a light receiving element may be arranged instead of optical fibers 40 and 41 to the connector and the two-cores/one-core conversion adapter, or optical fibers such as other side connectors or so may be arranged instead of optical fibers 40 and 41 at the end face of the optical wave guide circuit.

As described heretofore, according to an optical wave guide circuit and an optical transceiver using the optical wave guide circuit and the optical wave guide circuit of the present invention, it is possible to reduce the loss of the light in a transmitting light guide circuit. Moreover, it is possible to also reduce the cross talk during transmission and receiving.

What is claimed is:

1. An optical element comprising:
a transmitting light guide; and
a receiving light guide, wherein
said transmitting light guide is formed in a linear shape, and
said receiving light guide is formed in a curved shape.

2. An optical element according to claim 1, wherein
said transmitting light guide is arranged in parallel with a connection direction with a optical fiber.

3. An optical element according to claim 1, wherein
one side face of said receiving light guide is formed only with a curved face, and
another side face thereof is formed with a flat face and a curved face.

4. An optical element according to in claim 1, wherein
an end portion of said transmitting light guide is overlapped with an end portion of said receiving light guide in a vertical direction to a curved direction of said receiving light guide.

5. An optical element according to in claim 1, wherein
said receiving light guide is provided with a light beam control for controlling an angle of light.

6. An optical element comprising: a transmitting light guide; and a receiving light guide, wherein
the face of said transmitting light guide that is the farther from said receiving light guide is inclined, at least at the end of said transmitting light guide at said optical fiber side, so that the cross sectional area of said transmitting light guide becomes larger as it goes nearer to an optical fiber side.

7. An optical transceiver comprising:
an optical element, the optical element comprising:
a transmitting light guide; and
a receiving light guide, wherein
said transmitting light guide is formed in a linear shape, and
said receiving light guide is formed in a curved shape, a light projecting element arranged so as to oppose to the end face of said transmitting light guide; and
a light receiving element arranged so as to oppose to the end face of said receiving light guide.

8. A connector comprising:
an optical element, the optical element comprising:
a transmitting light guide; and
a receiving light guide, wherein
said transmitting light guide is formed in a linear shape, and
said receiving light guide is formed in a curved shape, and
an optical fiber is connected to said optical element so as to oppose to a position at which the end portion of said transmitting light guide is overlapped with the end portion of said receiving light guide.

9. A two-cores/one-core conversion adapter comprising:
an optical element, the optical element comprising:
a transmitting light guide; and
a receiving light guide, wherein
said transmitting light guide is formed in a linear shape, and
said receiving light guide is formed in a curved shape, and
a first optical fiber is connected to said optical element so as to oppose to a position at which the end portion of said transmitting light guide is overlapped with the end portion of said receiving light guide,
a second optical fiber is connected so as to oppose to another end portion of said transmitting light guide,
a third optical fiber is connected so as to oppose to another end portion of said receiving light guide, and
a connecting portion for connecting with a two-cores connection code is provided in a coating portion that said optical element is sealed.
